(19) United States
(12) Patent Application Publication
(10) Pub. No.: US 2005/0202268 A1
(43) Pub. Date: Sep. 15, 2005

(54) Three-dimensional shaped bodies having a leather-like surface

(75) Inventors: Christian Kotter, Wetter (DE); Martin Mangold, Neckargemund (DE); Reimund Piatkowski, Dortmund (DE)

Correspondence Address: HARNESS, DICKEY & PIERCE, P.L.C., P.O. BOX 828, BLOOMFIELD HILLS, MI, 48303, US

(73) Assignee: HP-CHEMIE PELZER RESEARCH AND DEVELOPEMENT LTD, WATERFORD (IE)

(21) Appl. No.: 10/516,630

(22) PCT Filed: May 28, 2003
(86) PCT No.: PCT/EP03/05615

§ 371 Date: May 12, 2005

(30) Foreign Application Priority Data
Jun. 1, 2002 (DE) 102 24 405.7
Oct. 17, 2002 (DE) 102 48 381.7

(51) Int. Cl. B29C 41/16

(52) U.S. Cl. 428/540; 264/87; 264/320; 264/129; 264/293; 264/400; 264/162; 264/483; 264/236; 264/318; 264/46.4; 264/255; 264/257

(57) ABSTRACT

The invention relates to a method for producing three-dimensional shaped skins having a leather-like surface, and to shaped bodies that can be obtained according to this method.

The invention relates to a method for preparing three-dimensional casting skins having a leather-like surface, and to the molded parts obtainable by such method.

The use of natural fibers in the automotive industry is steadily increasing. The main uses include rigid trim parts in the interior space and trunk. To date, vegetable fibers have been exclusively employed as the fibers. Fibers of animal origin, such as wool, silk or just leather fibers, have hardly been used to date, except for leather, of course.

In contrast to artificial leathers, which mostly consist of a PVC or polyurethane layer on a support woven or non-woven fabric, the main component of leather-fiber textile is leather fiber milled from leather scraps. It is held together by polymeric binders, such as natural latex, polyacrylates, polyvinyl acetates and their copolymers and various additives. The properties of the textile are determined by the kind of production, the density and, above all, by the components, i.e., leather fiber and binder. Since the effect of the leather fiber is quite prominent, it may be said that leather-fiber textile not only looks like leather, but also smells and feels like it. In contrast to leather, its properties are more uniform due to the usual production as sheeting.

To the end of the 1950's, leather-fiber textile was prepared by handicraft in so-called screen frames, but in the 1960's and 1970's, most plants converted to continuous production on modified endless-wire machines, as known from the paper industry.

Further optimizations of formulations and technology enabled a broad range of thicknesses and flexibilities to be covered, from paper-thin, namely 0.3 mm, to plywood-thick, 6 mm. Depending on its application, the leather-fiber textile either can be creased, like some leathers, or it is rigid and firm, very much like press-board. To date, this has allowed a field of application ranging from calendar and book covers to shoe heels or even the field of automobile interior trims.

The use of leather scraps is known from “Ullmanns Enzyklopädie der technischen Chemie”, 4. ed., vol. 16, p. 174. Thus, leather scraps can be defibrated and subsequently processed to leather fiber materials. These are single-layered sheet materials of leather fibers and binders. The leather fiber materials are then used for bag leather goods, but mainly in the production of shoes and for technical leather gaskets. For instance, the leather scraps are defibrated wet or dry in crushing mills, or defibrated wet in toothed disk mills and refiners, or in hollander beaters, wherein the fibers should have a length of from 0.1 to 15 mm. Water insoluble, particularly natural, or synthetic rubber latices as well as dispersions of acrylic ester, vinyl ester and isobutylene polymerizates and mixed polymerizates have proven useful as binders. The amount of binder is between 8 and 40%. In leather fiber materials having higher proportions (20 to 30%) of water-insoluble binders, the characteristics of the binder are thus predominant. In products having a lower content of binder (less than 20%), the fibrous character is predominant; such materials are more absorptive and more leather-like.

From DE 34 17 369 C2, a process is known for producing an injection-moldable composite material in which a polyester-cotton mixed fiber from waste fabric is fused with a polyolefin. However, the material thus prepared lacks both a sufficient water-absorbing capacity and the feel characteristics typical of leather.

DE 21 20 149 A1 describes weather-resistant and torsion-free plates, tubes, rods and other molded articles consisting of binders and fillers made of used material, including waste from paper, cardboard articles, knitted goods, cottons, linens, synthetic fibers, leather, rags, hay, straw, foliage, grass, shells of cereals and fruits, pits and peels of fruits and potatoes as well as metal chips, grains, powders, metals, polystyrene, waste from plastic processing, natural fibers such as jute, sisal or hemp. Information about the amounts of filler materials employed is not included.

WO 94/02300 describes molded parts having leather-like surface properties in the automotive field, comprising a thermoplastic or elastic thermosetting material and milled leather scraps in an amount of up to 95% by weight, based on the molded part.

In contrast, the object of the present invention is to provide a method for immediately preparing three-dimensional molded parts from leather fiber materials.

The above object is achieved by a method for the preparation of three-dimensional casting skins having a leather-like surface, characterized in that the porous surface of a vacuum tool having the geometry of the three-dimensional molded part is introduced into a pulp which contains leather fibers, suspending agents and binders, leather fibers are deposited in the desired layer thickness from the pulp on the surface of the vacuum tool by applying a vacuum in the vacuum tool, followed by transferring the surface of the vacuum tool to a press tool to densify the leather fiber layer, optionally followed by surface profiling and partial or complete drying, and providing the leather fiber surface with a finish.

The main raw material is the leather fibers. They are primarily classified according to the kind of tanning. The main tanning methods are chrome tanning (wet blue) and vegetable tanning, and recently also glutardialdehyde tanning (wet white). Chrome-tanned fibers are the largest fraction. They are obtained, for example, from the tannery in the form of chrome shavings.

A cow hide has a non-uniform thickness, mostly from 4 to 5 mm, and the desired leather is to have a thickness of mostly around 1 to 1.5 mm. Thus, it is desired to cleave the hide into several layers and then to provide them with equal thicknesses by means of rotating cutters. Without tanning, this is not possible, because the hide is too supple. After full tanning, it is too expensive because a major portion of the chemicals employed for tanning would be lost together with the shavings.

Therefore, the hide is subjected to preliminary tanning prior to being shaved, to obtain a leather precursor, the wet blue and the shavings. This means that the shavings must be tanned, greased and dyed by analogy with the tanning process. Since chrome-tanned leathers are particularly soft and flexible in general, it is also possible to prepare a particularly soft leather fiber textile from chrome shavings.

Leather scraps from vegetable tanning are predominantly obtained in the form of gratings left from the punching of shoe soles. Such leathers are fully tanned, very firm, but also very rigid. For parts which must have a high dimensional stability, it is the ideal raw material. In contrast, where suppleness is desired, higher formulation demands are required. Nevertheless, vegetable tanning is very interesting, in particular, for automobile interior trims, because, in contrast to chrome tanning, it enables lower shrinkage when subjected to high temperatures. In addition, embossability is clearly better than that of leather fiber textile from chrome-tanned scraps.

Glutardialdehyde tanning is mostly applied in combination with other tanning methods and yields chrome-free leathers having a good heat-shrinkage behavior. The respective shavings are tanned even more weakly as compared to the chrome shavings. The preparation of leather fiber textile from wet white shavings is relatively tedious, and the suppleness to which we are used from chrome shavings could not be achieved to date.

Although mixing with non-collagenous fibers, such as cellulose, cotton or plastic fibers, for example, polyamide fibers, can cause advantages, such as an increase in production speed or the improvement of mechanical properties, these fibers, which are mostly longer, often cause problems relating to the surface smoothness after coating. In addition, the leather characteristics are greatly reduced as the content of foreign fibers increases. Nevertheless, the present invention also comprises the use of such foreign fibers.

The production of leather fiber textile is similar to that of paper. For example, the leather scraps are precomminuted dry in a cutting mill, followed by wet milling to the desired fiber length, preferably from 0.1 to 15 mm, especially from 0.2 to 3 mm. At this time, the dyes and greasing agents are also added. The greasing agent is of particular importance. The fat-water emulsion must be stabilized in such a way that the fat completely deposits on the leather fiber and intrudes in its capillary spaces. The greasing agent also determines the degree of flocculation. If the fibers flocculate too finely, although an excellent molded part and thus an excellent surface is obtained, the leather fiber textile becomes too hard. Too coarse a flocculation results in a good smoothness, but in too little fiber coherence and thus a poor firmness. Of course, the greasing agent should be low fogging.

The binder in the pulp to be employed according to the invention preferably consists of thermoplastic and/or thermosetting material and is selected, in particular, from natural rubber, polyurethanes, polyacrylates, dispersions of acrylic esters, vinyl esters and isobutylene polymers and mixed polymers, or a vinyl acetate. The pulp contains the above mentioned binder, for example, in an amount of from 10 to 50% by weight, especially in an amount of from 15 to 30% by weight.

The binder is preferably added as a latex. Latex consists of tiny polymer particles which are suspended in water. In order to keep such a suspension stable, the latex particles mostly have an electric charge on their surface. Thus, they repel each other; agglomeration and precipitation is prevented. If the leather fibers have a charge opposite to that of the latex particles, these will coagulate directly on the fiber. By optimally adjusting the charge proportions, it is possible to employ very large amounts of binders without putting a load on the waste water processing plant.

Into the thus obtained pulp, the porous surface of a vacuum tool, which may have both positive and negative shape, having the geometry of the three-dimensional molded part is introduced. On the surface of the vacuum tool, the leather fibers deposit in a desired layer thickness. As soon as the desired amount of leather fibers has been deposited on the surface of the vacuum tool, the vacuum tool with the leather fibers adhering to its surface is transferred to a press tool, and the leather fiber layer is dewatered and densified, optionally surface-profiled, and during this or in a separate step, it is optionally subjected to partial or complete drying and provided with a finish. Subsequently, the surface may be smoothed by glazing and grinding.

Dewatering and drying are significantly more difficult as compared to paper production. On the one hand, the leather fiber releases the water much more slowly, and on the other hand, leather fibers must be dried at very much lower temperatures. This is because leather will contract at the so-celled shrinkage temperature and subsequently hornify on the surface due to hydrolytic processes.

In the finishing step, the leather fiber textile is provided with the same appearance as that of leather. The coating, coloring, printing and embossing are preferably effected with the same formulations and, in part, by the same methods as for leather.

According to the present invention, it is particularly preferred to employ the porous surface of a sintered powder metal, a ceramic, a metal foam, a plastic foam or a screen for preparing the molded part. This porous surface has the geometry of the three-dimensional molded part, for example, an armrest or dashboard of a motor vehicle.

Although leather fibers in any suspension media may be employed in principle, it is particularly preferred according to the invention to employ an aqueous pulp.

It is particularly preferred according to the invention to employ a pulp which contains leather fibers in an amount of from 0.1 to 10% by weight, especially in an amount of from 0.5 to 2% by weight.

The desired surface properties of the molded parts to be prepared can be achieved by per se known methods of embossing, grinding, plasma treatment, corona treatment, sand blasting or shot blasting.

In the method according to the invention, it is particularly preferred to apply the leather fibers in a dry layer thickness of from 0.1 to 6 mm, especially from 0.1 to 2 mm, more especially from 0.3 to 0.6 mm. To the skilled person, it is obvious that the leather fibers must be applied wet from the leather fiber pulp at a higher density because they will shrink to some extent after drying. The term “dry layer thickness” naturally relates to those molded parts which still have a low residual moisture content of, for example, from 15 to 30% after having been dried, for example, at 70° C. for 2 minutes.

During the drying step, the binder forms a film. This involves polymerization, polycondensation and/or cross-linking of the binder. Naturally, this also causes mutual cross-linking of the collagen fibers and any foreign fibers through the binder.

To prepare molded parts having a complicated geometry, it is possible to employ a mold with mobile slides for forming undercuts. This is a technique which is usual, in particular, in the automobile field for the preparation of corresponding molded parts from thermoplastic and/or thermosetting materials.

After the molding and, in particular, after release from the mold, it is possible, for example, to provide the molded part with a foam backing or injection-molded backing.

The finish can be applied to the dried leather fiber layer in a per se known manner. This may be done, for example, by coating or spraying onto the leather fiber layer after drying, and/or onto the surface of the mold prior to densifying.

By means of the present invention, it is possible to prepare a number of three-dimensional molded parts having a leather-like surface.

According to the present invention, it is particularly preferred that the molded parts having a leather-like surface comprise furniture, clothing, accessories, installation parts, veneers and trims, especially for the automotive field. In the automotive field, suitable items include, in particular, floor trims, trunk trims, roof trims, dashboard trims, switches, gearshift levers, doorknobs and/or steering wheel covers, as well as seat cushions, seat rests or rear shelves etc.

In practice, the leather fibers can be employed for any purpose in which the optical properties play an essential role. In addition, a sound-insulating effect is also important, however.

### APPLICATION EXAMPLES

### Example 1

(a) Preparation of the Leather Fiber Pulp

500 g of aqueous leather fiber pulps with leather fibers with an average fiber length of 1 mm and a solid content of 2% as well as an addition of 20% fat, based on the dry fiber, was admixed with usual tanning agent and aluminum sulfate. This pulp was added to a 1000 ml beaker. To this, 30 g of commercially available natural latex with 3% solids content was added. Immediately after the latex addition, mixing was performed for 2 minutes.

(b) Preparation of the Molded Part

A model of a dashboard was immersed into the leather fiber pulp prepared according to (a). The model of the dashboard consisted of a porous ceramic body with an average pore size of 0.02 mm. The surface which was not immersed in the pulp was not porous. By sucking the ceramic body from the back, part of the leather fibers deposited on the surface of the ceramic molded part.

The molded part was withdrawn from the leather fiber pulp, maintaining a reduced pressure.

Then, in a further process step, the dashboard model was transferred into a mold, and the deposited leather fiber coating was dried by vacuum sucking.

Subsequently, the exposed surface of the leather fibers was provided with a finish of PU or other materials known from the leather industry and pressed in a per se known manner.

1-17. (canceled)

18. A method for the preparation of three-dimensional casting skins having a leather-like surface, comprising the steps of:
applying a pulp comprising leather fibers, suspending agents, binders and optionally additives, to the porous surface of a vacuum tool having the geometry of the three-dimensional molded part;
applying a vacuum in the vacuum tool to deposit said pulp to a desired layer thickness along said porous surface to form a casting skin; and
transferring the casting skin to a press tool and applying pressure to remove moisture and densify the casting skin.

19. The method according to claim 18, further characterized in that said casting skin is profiled.

20. The method according to claim 18, further characterized in that said casting skin is dried.

21. The Method according to claim 18, further characterized in that said casting skin is provided with a surface finish.

22. The method according to claim 18, characterized in that the porous surface of said vacuum tool if formed from a material selected from the group consisting of a sintered powder metal, a ceramic, a metal foam, and a plastic foam or screen.

23. The method according to claim 18, characterized in that said pulp contains leather fibers in an amount of from 0.1 to 10% by weight.

24. The method according to claim 18, characterized in that said pulp contains leather fibers in an amount of from 0.5 to 2% by weight.

25. The method according to claim 18, characterized in that the surface properties of the casting skin can be modified by embossing, grinding, plasma treatment, corona treatment, sand blasting or shot blasting.

26. The method according to claim 18, characterized in that a pulp is employed which contains leather fibers of a length of from 0.1 to 15 mm.

27. The method according to claim 18, characterized in that a pulp is employed which contains leather fibers of a length of from 0.3 to 3 mm.

28. The method according to claim 18 characterized in that said binder is selected from the group consisting of natural rubber, polyurethane, polyacrylates, dispersions of acrylic esters, vinyl esters and isobutylene polymers and mixed polymers, or a vinyl acetate.

29. The method according to claim 18, characterized in that said binder is present in an amount of from 10 to 50% by weight, based on the dry weight.

30. The method according to claim 18, characterized in that said binder is present in an amount of from 15 to 30% by weight, based on the dry weight.

31. The method according to claim 18, characterized in that the casting skin has an average dry layer thickness of from 0.1 to 6 mm.

32. The method according to claim 18, characterized in that the casting skin has an average dry layer thickness of from 0.1 to 2 mm.

33. The method according to claim 20, characterized in that the drying step comprises the polymerization, polycondensation, cross-linking and/or film forming of the binder.

34. The method according to claim 18, characterized in that a mold with mobile slides for forming undercuts is employed.

35. The method according to claim 18, characterized in that the casting skin is released from the surface of the vacuum tool and provided with a foam backing or injection-molded backing.

36. The method according to claim 18 characterized in that a pulp is employed which further contains non-collagenous fibers.

37. The method according to claim 36 characterized in that said non-collagenous fibers are selected from the group consisting of cellulose, cotton and/or plastic fibers.

38. A three-dimensional molded part having a leather-like surface and obtainable by a method according to claim 18.

39. The molded part having a leather-like surface according to claim 38, comprising furniture, clothing, accessories, installation parts, veneers and trims.

40. The molded part according to claim 39, characterized in that said trim are selected from the group consisting of floor trims, pillar trims, trunk trims, door trims, dashboard trims, switches, gearshift levers, seat cushions, seat rests, doorknobs and steering wheel covers.
